(19) United States
(12) Patent Application Publication
(10) Pub. No.: US 2023/0190415 A1
(43) Pub. Date: Jun. 22, 2023

(54) SHELL-SHAPED DENTAL APPLIANCE AND ITS SHELL-SHAPED BODY

(71) Applicant: WUXI EA MEDICAL INSTRUMENTS TECHNOLOGIES LIMITED, Wuxi City (CN)

(72) Inventors: Ketuo ZHOU, Shanghai (CN); Lei HUANG, Shanghai (CN)

(73) Assignee: WUXI EA MEDICAL INSTRUMENTS TECHNOLOGIES LIMITED, Wuxi City (CN)

(21) Appl. No.: 18/109,737

(22) Filed: Feb. 14, 2023

Related U.S. Application Data
(63) Continuation-in-part of application No. 16/652,658, filed on Mar. 31, 2020.

(30) Foreign Application Priority Data
Mar. 16, 2018 (CN) 201820368132.3

(51) Int. Cl. A61C 7/08

(52) U.S. Cl. CPC A61C 7/08

(57) ABSTRACT

The present application provides a body of a dental appliance, the body is a one-piece shell which forms a cavity for receiving a plurality of teeth and a first mounting surface for mounting a first accessory by bonding the first mounting surface and a second mounting surface of the first accessory, where the first mounting surface has artificially designed geometry and edge contour, which substantially match that of the second mounting surface.

### FIELD OF THE APPLICATION

The present application generally relates to a shell-shaped dental appliance, and more specifically to a shell-shaped dental appliance mounted with a standard accessory, and its shell-shaped body.

### BACKGROUND

Due to advantages on aesthetic appearance, convenience and hygiene etc., shell-shaped dental appliances (e.g. invisible tooth repositioner and retainer etc.) made of polymer materials become more and more popular. A conventional shell-shaped dental appliance is usually a one-piece shell which forms a cavity for receiving a plurality of teeth.

When a shell-shaped dental appliance is used for a dental treatment (e.g. orthodontic treatment or orthognathic treatment), in some circumstances, an accessory such as Twin-Block, Bracket, Button, Bite Stop and Occlusal Pad etc. needs to be mounted on the shell-shaped dental appliance to achieve treatment target.

In some cases, accessories may be manufactured separately, and mounted on the shell-shaped dental appliance by adhesion, welding, or mechanical connection etc.

In some examples, accessories are standard parts having a mounting surface with a predetermined standard geometry. However, the geometry of the outer surface of a shell-shaped dental appliance is highly correlated with the geometry of the teeth. Therefore, the geometries of engagement surfaces of the accessory and the shell-shaped dental appliance probably do not match, which affects the bonding strength between the accessory and the shell-shaped dental appliance.

In some other examples, an accessory is a non-standard part, and it is such fabricated that the geometry of its mounting surface matches the geometry of the area on the shell-shaped dental appliance where it is to be mounted. However, this increases the complexity of the manufacture of accessories and decreases universality of the same.

In view of the above, it is necessary to provide a new shell-shaped dental appliance.

### SUMMARY

In one aspect, the present application provides a body of a dental appliance, the body is a one-piece shell which forms a cavity for receiving a plurality of teeth and a first mounting surface for mounting a first accessory by bonding the first mounting surface and a second mounting surface of the first accessory, wherein the first mounting surface has artificially designed geometry and edge contour which substantially match that of the second mounting surface.

In some embodiments, the first mounting surface is one of a plane and a revolved surface.

In some embodiments, the whole first mounting surface is raised outwards, and there is space between a surface opposite to the first mounting surface and a tooth/teeth beneath it.

In some embodiments, the first accessory is one of the following: occlusal pad, button, bracket, bite stop and twin-block.

In some embodiments, the first mounting surface is for mounting the first accessory by adhesion.

In some embodiments, the first mounting surface is slightly larger than the second mounting surface.

In some embodiments, the first mounting surface constitutes a part of the outer surface of the body.

In some embodiments, the body forms an outward protruding structure on the edge of the first mounting surface, and the first mounting surface is surrounded by the outward protruding structure.

In some embodiments, a surface opposite to the first mounting surface is in contact with a tooth/teeth beneath it on at least one point.

In some embodiments, the first mounting surface is part of the outer surface of the body, and the outer surface of the body generally conforms to the teeth the cavity receives except the first mounting surface.

In another aspect, the present application provides a dental appliance, which comprises a body, which is a one-piece shell and forms a cavity for receiving a plurality of teeth and a first mounting surface; and a first accessory having a second mounting surface; wherein the first mounting surface has artificially designed geometry and edge contour which substantially match that of the second mounting surface, and the first accessory is mounted on the body by bonding the first mounting surface and the second mounting surface.

In some embodiments, the first mounting surface is one of a plane and a revolved surface.

In some embodiments, the whole first mounting surface is raised outwards, and there is space between a surface opposite to the first mounting surface and a tooth/teeth beneath it.

In some embodiments, the first accessory is one of the following: occlusal pad, button, bracket, bite stop and twin-block.

In some embodiments, the first mounting surface constitutes a part of the outer surface of the body.

In some embodiments, the first accessory is mounted on the first mounting surface by adhesion.

In some embodiments, the first mounting surface is slightly larger than the second mounting surface.

In some embodiments, the body forms an outward protruding structure on the edge of the first mounting surface, and the first mounting surface is surrounded by the outward protruding structure.

In some embodiments, a surface opposite to the first mounting surface is in contact with a tooth/teeth beneath it on at least one point.

In some embodiments, the first mounting surface is part of the outer surface of the body, and the outer surface of the body generally conforms to the teeth the cavity receives except the first mounting surface.

In another aspect, the present application provides a system for aligning teeth of a patient, wherein it comprises at least two dental appliances for incrementally aligning teeth of a patient from a first tooth arrangement to a second tooth arrangement, each of the at least two dental appliances comprises a body, which is a one-piece shell and forms a cavity for receiving the teeth of the patient and a first mounting surface on a predetermined position for mounting a first accessory by bonding the first mounting surface and a second mounting surface of the first accessory, wherein the first mounting surface has artificially designed geometry and edge contour, wherein the first mounting surfaces of the bodies of the at least two dental appliances are same.

In some embodiments, the first mounting surface's geometry and edge contour substantially match that of the second mounting surface.

In some embodiments, of each of the at least two dental appliances, the first mounting surface is part of the outer surface of the body, and the outer surface of the body generally conforms to a corresponding tooth arrangement except the first mounting surface.

### BRIEF DESCRIPTION OF THE DRAWINGS

The above and other features of the present application will be further illustrated below with reference to figures and their detailed description. It should be appreciated that these figures only show several exemplary embodiments according to the present application, so they should not be construed as limiting the protection scope of the present application. Unless otherwise specified, the figures are not necessarily drawn to scale, and similar reference numbers therein denote similar components.

FIG. 1A schematically illustrates a shell-shaped dental appliance according to one embodiment of the present application;

FIG. 1B schematically illustrates a shell-shaped body of the shell-shaped dental appliance shown in FIG. 1A;

FIG. 1C schematically illustrates a cross-sectional view of the shell-shaped body shown in FIG. 1B taken along line A-A;

FIG. 2 schematically illustrates a shell-shaped dental appliance according to another embodiment of the present application;

FIG. 3 schematically illustrates a shell-shaped dental appliance according to a further embodiment of the present application;

FIG. 4A schematically illustrates the engagement of the outer surface of an accessory mounting area and an accessory standard mounting surface according to one embodiment of the present application;

FIG. 4B schematically illustrates the engagement of the outer surface of an accessory mounting area and an accessory standard mounting surface according to another embodiment of the present application;

FIG. 4C schematically illustrates the engagement of the outer surface of an accessory mounting area and an accessory standard mounting surface according to a further embodiment of the present application;

FIG. 4D schematically illustrates the engagement of the outer surface of an accessory mounting area and an accessory standard mounting surface according to a further embodiment of the present application;

FIG. 5A schematically illustrates a cross-section of an accessory mounting area and a button mounted thereon according to another embodiment of the present application;

FIG. 5B schematically illustrates a cross-section of an accessory mounting area and a button mounted thereon according to another embodiment of the present application;

FIG. 5C schematically illustrates a cross-section of an accessory mounting area and a button mounted thereon according to another embodiment of the present application;

FIG. 6A schematically illustrates a cross-section of an accessory mounting surface and a button mounted thereon according to another embodiment of the present application;

FIG. 6B schematically illustrates a cross-section of an accessory mounting surface and a button mounted thereon according to another embodiment of the present application;

FIG. 6C schematically illustrates a cross-section of an accessory mounting surface according to another embodiment of the present application;

FIG. 6D schematically illustrates a cross-section of an accessory mounting surface according to another embodiment of the present application;

FIG. 7 schematically illustrates a shell-shaped dental appliance according to another embodiment of the present application; and

FIG. 8 schematically illustrates a cross-section of an accessory mounting surface and a button mounted thereon according to another embodiment of the present application.

### DETAILED DESCRIPTION OF ILLUSTRATED EMBODIMENTS

In the following detailed description, reference is made to the accompanying drawings, which form a part thereof. Exemplary embodiments in the detailed description and figures are only intended for illustration purpose and not meant to be limiting. Inspired by the present application, those skilled in the art can understand that other embodiments may be utilized and other changes may be made, without departing from the spirit or scope of the present application. It will be readily understood that aspects of the present application described and illustrated herein can be arranged, replaced, combined, separated and designed in a wide variety of different configurations, all of which are explicitly contemplated and make part of the present application.

In view of the above problems of the conventional shell-shaped dental appliance, the Inventors of the present application has developed a new shell-shaped dental appliance and its shell-shaped body after extensive research.

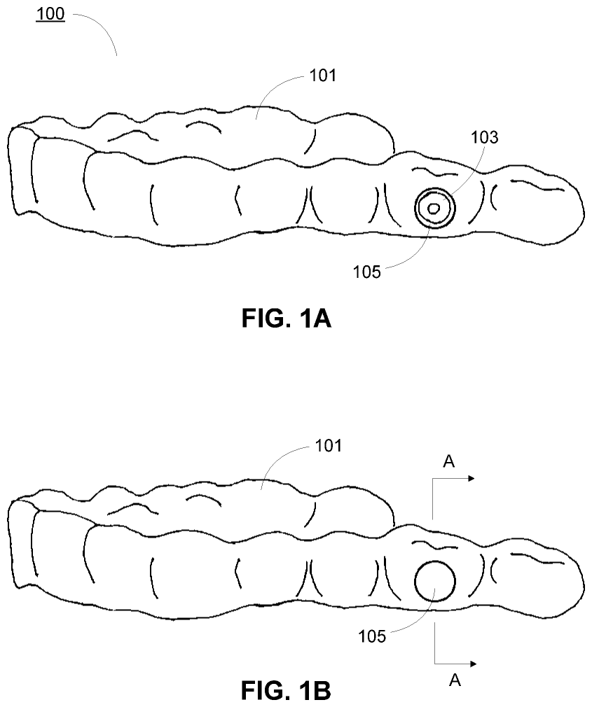

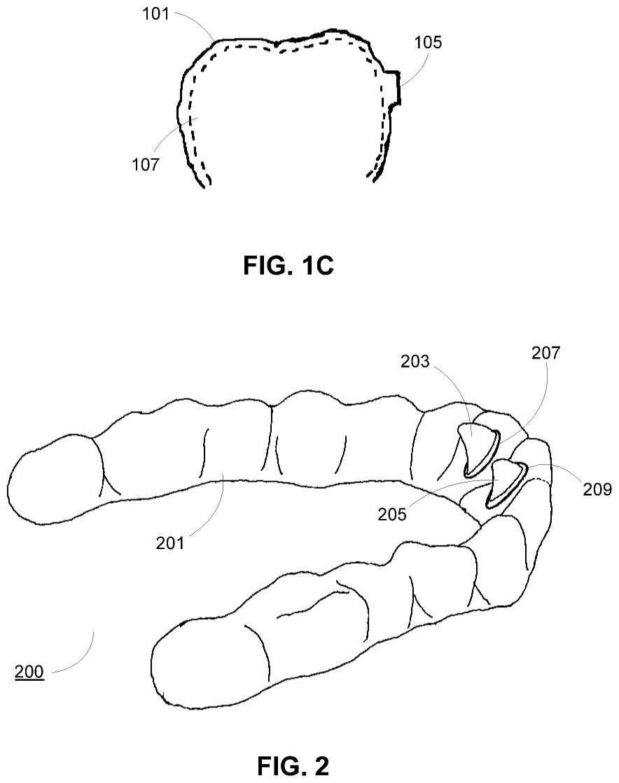

Referring to FIG. 1A, it schematically illustrates a shell-shaped dental appliance 100 according to one embodiment of the present application.

The shell-shaped dental appliance 100 comprises a shell-shaped body 101 and a button 103 fixed on the outer surface of the shell-shaped body 101. An accessary mounting area 105 is formed on the shell-shaped body 101, and the outer surface of the accessory mounting area 105 has an artificially designed geometry and contour, which substantially matches that of a standard mounting surface on the bottom of the button 103, so that the button 103 can be fixed on the shell-shaped body 101 by bonding the outer surface of the mounting area 105 and the standard mounting surface of the button 103.

In some embodiments, an elastic element (e.g., a rubber band or a spring) may be coupled to shell-shaped dental appliances worn on the upper jaw and the lower jaw respectively via buttons, to generate a force of traction therebetween, thereby implementing adjustment of the position of the lower jaw.

In some embodiments, the button 103 may be fixed on the shell-shaped body 101 by adhesion or welding.

Referring to FIG. 1B, it schematically illustrates the shell-shaped body 101 of the shell-shaped dental appliance 100 shown in FIG. 1A.

The outline (edge contour) of the accessory mounting area 105 is circular. Inspired by the present application, it is understood that the outline of the accessory mounting area 105 may also be in other shapes, for example, rectangle, ellipse, and polygon etc.

Referring to FIG. 1C, it schematically illustrates a cross-section of the shell-shaped body 101 shown in FIG. 1B taken along line A-A.

The shell-shaped body 101 forms a cavity 107 for receiving teeth, where except for the accessory mounting area 105, the geometry of the cavity 107 substantially matches the teeth under a corresponding tooth arrangement. For example, if the shell-shaped dental appliance 100 is an orthodontic repositioner, the geometry of the cavity 107 matches a target tooth arrangement of a corresponding treatment step.

In one embodiment, the whole accessory mounting area 105 protrudes outwards. When the shell-shaped dental appliance 100 is worn on the teeth, the inner surface of the accessory mounting area 105 is not in contact with the teeth (outlined by the dotted line).

Referring to FIG. 2, it schematically illustrates a shell-shaped dental appliance 200 according to another embodiment of the present application.

The shell-shaped dental appliance 200 comprises a shell-shaped body 201 and bite stops 203 and 205 fixed on the outer surface of the shell-shaped body 201, where accessary mounting areas 207 and 209 are formed on the shell-shaped body 201, and the outer surfaces of the accessory mounting areas 207 and 209 has an artificially designed standard geometry and contour, which substantially matched that of standard mounting surfaces of the bite stops 203 and 205, so that the bite stops 203 and 205 can be respectively fixed on the mounting areas 207 and 209 by bonding their standard mounting surfaces with the outer surfaces of the latter respectively.

The shell-shaped dental appliance 200 may be used to open occlusion for an “anterior crossbite” case. When the shell-shaped dental appliance 200 is worn on the teeth, anterior teeth of the opposite jaw will abut against an end of the bite stops 203 and 205 adjacent to the cutting ends of the teeth, thereby opening the occlusion.

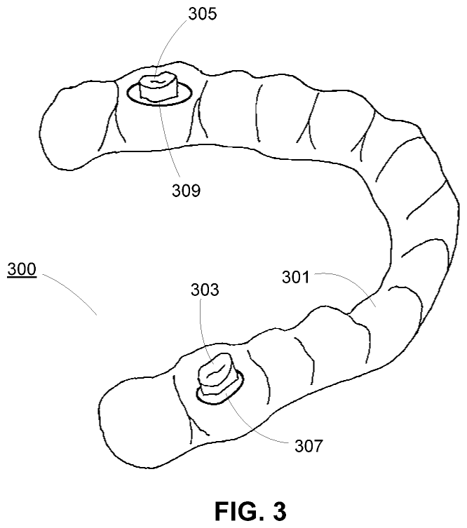

Referring to FIG. 3, it schematically illustrates a shell-shaped dental appliance 300 according to a further embodiment of the present application.

The shell-shaped dental appliance 300 comprises a shell-shaped body 301 and occlusal pads 303 and 305 fixed on the outer surface of posterior areas of both sides of the shell-shaped body 301, where accessory mounting areas 307 and 309 are respectively formed in the posterior areas of both sides of the shell-shaped body 301, and the outer surfaces of the accessory mounting areas 307 and 309 have artificially designed standard geometry and contour, which substantially match that of the standard mounting surfaces of the occlusal pads 303 and 305, so that the occlusal pads 303 and 305 can be respectively fixed on the mounting areas 307 and 309 by bonding their standard mounting surfaces with the outer surfaces of the latter respectively.

When the shell-shaped dental appliance 300 is worn on the teeth, posterior teeth of the opposite jaw will abut against the occlusal pads 303 and 305, thereby opening the occlusion.

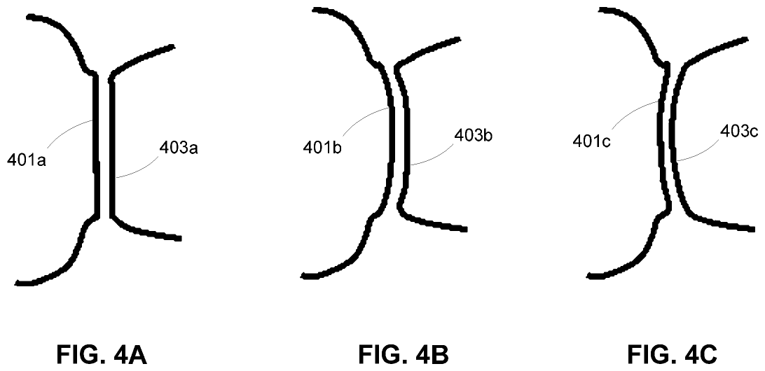

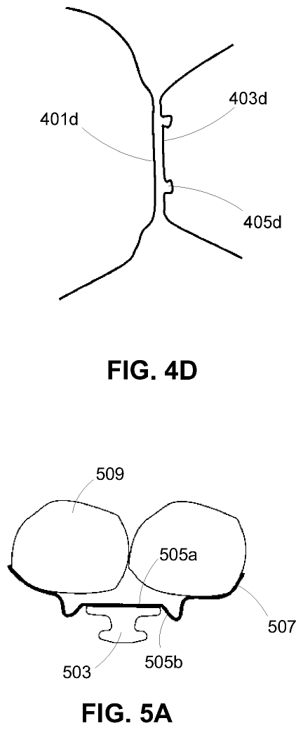

Referring to FIG. 4A, it schematically illustrates the engagement of the outer surface 401a of an accessory mounting area and an accessory standard mounting surface 403a according to one embodiment of the present application. In this embodiment, both the outer surface 401a of the accessory mounting area and the accessory standard mounting surface 403a are planes.

Referring to FIG. 4B, it schematically illustrates the engagement of the outer surface 401b of an accessory mounting area and an accessory standard mounting surface 403b according to one embodiment of the present application. In this embodiment, the outer surface 401b of the accessory mounting area is a convex arc surface, and the accessory standard mounting surface 403b is a concave arc surface matching with the convex arc surface.

Referring to FIG. 4C, it schematically illustrates the engagement of the outer surface 401c of an accessory mounting area and an accessory standard mounting surface 403c according to one embodiment of the present application. In this embodiment, the outer surface 401c of the accessory mounting area is a concave arc surface, and the accessory standard mounting surface 403c is a convex arc surface matching with the concave arc surface.

Referring to FIG. 4D, it schematically illustrates the engagement of the outer surface 401d of an accessory mounting area and an accessory standard mounting surface 403d according to one embodiment of the present application. In this embodiment, the outer surface 401d of the mounting area is a plane, and the contour of the accessory standard mounting surface 403d is a plane on which a groove 405d for receiving an adhesive is formed. When the adhesive is used to bond the accessory to the accessory mounting area, the groove 405d can receive the adhesive. This can prevent the adhesive from overflowing to a certain degree on the one hand, and can enhance the bonding strength on the other hand.

Inspired by the present application, it is understood that to enhance bonding strength, a structure such as dots or stripes may be formed on at least one of the outer surface of an accessory mounting area and an accessory standard mounting surface.

In some embodiments, area of at least one of the outer surface of an accessory mounting area and an accessory standard mounting surface is greater than that of the other. So, when adhesive is used to fix the accessory, excess adhesive will surround the edge of the one with a smaller area, and enhance the bonding strength. In one embodiment, the area of the outer surface of the accessory mounting area is greater than that of the accessory standard mounting surface, or put it another way, after the accessory is fixed on the shell-shaped body, the coverage of the outer surface of the accessory mounting area exceeds the accessory standard mounting surface.

In some embodiments, the outer surface of an accessory mounting area and an accessory standard mounting surface may be planes or revolved surfaces, where the generatrix of a revolved surface may be any suitable line, e.g. a straight line, a curve or a stepped line.

In some embodiments, a 100% match between the geometries of the outer surface of an accessory mounting area and an accessory standard mounting surface is not required, it only requires that the matching degree is within a tolerance of a fixation method (namely, as long as the matching degree ensures a certain bonding strength).

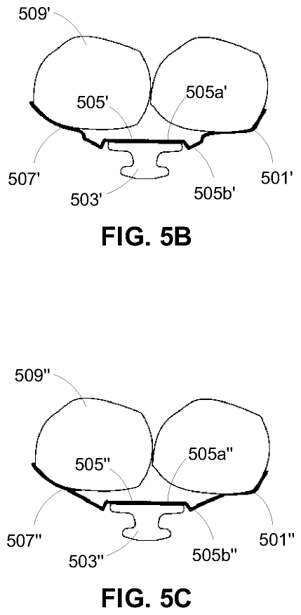

Referring to FIG. 5A, it schematically illustrates a cross-section of an accessory mounting area 505 and a button 503 mounted thereon according to another embodiment.

The accessory mounting area 505 is formed on a shell-shaped body 501 of a shell-shaped dental appliance, the shell-shaped body 501 forms a cavity 507 for receiving teeth 509. The accessory mounting area 505 includes an accessory mounting surface 505a and an outward protruding structure 505b on the edge of the accessory mounting surface 505a, where the accessory mounting surface 505a is surrounded by the outward protruding structure 505b. The outward protruding structure 505b rises outward from the shell-shaped body 501, and is higher than a part of the accessory mounting surface 505a that is close to the outward protruding structure 505b.

The accessory mounting surface 505a has artificially designed geometry and contour, and constitutes a standard mounting surface. In other words, the geometry of the accessory mounting surface 505a is different from corresponding part of tooth surface. The accessory mounting surface 505a substantially matches the mounting surface on the bottom of the button 503.

In one embodiment, button 503 is mounted on the accessory mounting area 505 by adhesion, excess adhesive bonds the side wall of the bottom the button 503 and the inner wall of the outward protruding structure 505b, to enhance the bonding strength.

In one embodiment, the inner size of the outward protruding structure 505b decreases from top to bottom (if cross-section of the inner wall of the outward protruding structure 505b at a plane, which is perpendicular with its protruding direction, is circular, then the inner size is inside diameter), such that the inner wall of the outward protruding structure 505b forms a guide surface for guiding button 103 to engage with the accessory mounting surface 505a, which makes it easier to mount button 103.

In the embodiment illustrated in FIG. 5A, the cross-section of the top of the outward protruding structure 505b is curve shaped. Inspired by the present application, it is understood that it may be other shapes.

Referring to FIG. 5B, it schematically illustrates a cross-section of an accessory mounting area 505′ and a button 503′ mounted thereon according to another embodiment.

A shell-shaped body 501′ forms a cavity 507′ for receiving teeth 509′ and the accessory mounting area 505′ for the mounting button 503′. The accessory mounting area 505′ includes an accessory mounting surface 505a′ and an outward protruding structure 505b′ which surrounds the former. In this embodiment, the cross section of the top of the outward protruding structure 505b′ is an oblique line with the outside end higher than the inside end.

Referring to FIG. 5C, it schematically illustrates a cross-section of an accessory mounting area 505″ and a button 503″ mounted thereon according to another embodiment.

A shell-shaped body 501″ forms a cavity 507″ for receiving teeth 509″ and the accessory mounting area 505″ for mounting the button 503″. The accessory mounting area 505″ includes an accessory mounting surface 505a″ and an outward protruding structure 505b″ which surrounds the former. In this embodiment, the slope between the outward protruding structure 505b″ and the shell-shaped body 501″ is very gentle/smooth, such that the accessory mounting area 505″ is generally a gently raised bump with its middle part caved to form the accessory mounting surface 505a″. Such structure is easier to thermoform, and it is easier to remove a shell-shaped body from a positive model on which the shell-shaped body is thermoformed.

In one embodiment, cross section (including height and/or shape) of outward protruding structure at any position may remain the same. In another embodiment, cross section of outward protruding structure may vary with position.

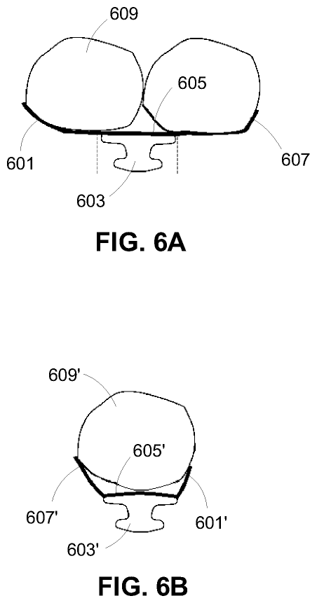

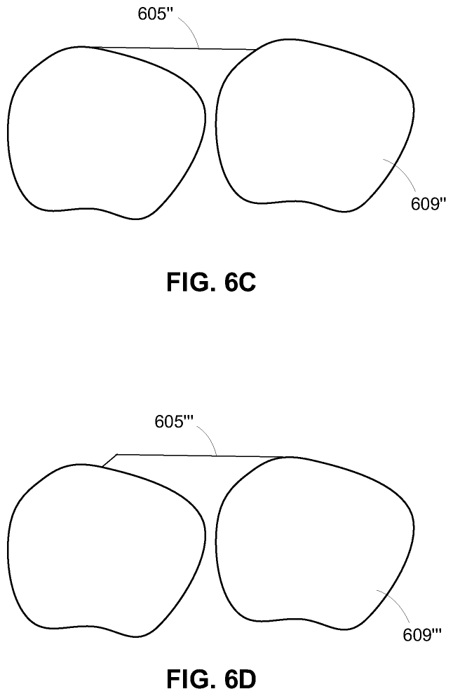

Referring to FIG. 6A, it schematically illustrates a cross-section of an accessory mounting surface 605 and a button 603 mounted thereon according to another embodiment.

A shell-shaped body 601 forms a cavity 607 for receiving teeth 609 and the accessory mounting surface 605 having the button 603 mounted thereon.

The accessory mounting surface 605 has artificially designed geometry and contour, and constitutes a standard mounting surface. In other words, the geometry of the accessory mounting surface 605 is different from the tooth surface beneath it. The accessory mounting surface 605 substantially matches the mounting surface on the bottom of the button 603.

The opposite surface (the surface opposite to the accessory mounting surface 605) of the accessory mounting surface 605 is in contact with each of two adjacent teeth on at least one point respectively, such that the button 603 has support along its height direction on these contact points. On the one hand, such structure is able to prevent the accessory mounting surface 605 from collapsing. On the other hand, such structure shortens the distance between the accessory mounting surface 605 and teeth as much as possible, and enhances local mechanical strength of the shell-shaped body 601 and makes it easier to remove the shell-shaped body 601 from a positive model on which it is thermoformed.

In one embodiment, a mark, such as a cross mark, may be formed at the center of the accessory mounting surface 605, to help locate the accessory mounting surface 605.

Referring to FIG. 6B, it schematically illustrates a cross-section of an accessory mounting surface 605′ and a button 603′ mounted thereon according to another embodiment.

A shell-shaped body 601′ forms a cavity 607′ for receiving teeth 609′ and the accessory mounting surface 605′ having the button 603′ mounted thereon. The accessory mounting surface 605′ is a curved surface which caves in towards the teeth 609′, and its edge contour is circular. The mounting surface on the bottom of the button 603′ matches the accessory mounting surface 605′. The opposite surface of the accessory mounting surface 605′ is in contact with the corresponding tooth at a point around the center of the opposite surface.

Referring to FIG. 6C, it schematically illustrates a cross-section of an accessory mounting surface 605″ according to another embodiment. In this embodiment, a surface opposite to the accessory mounting surface 605″ is in point contact with each of two adjacent teeth near its edge, and this provide support for the accessory mounting surface 605″.

Referring to FIG. 6D, it schematically illustrates a cross-section of an accessory mounting surface 605′″ according to another embodiment. In this embodiment, a surface opposite to the accessory mounting surface 605′″ is in point contact with only one tooth near its edge, and this provide support for the accessory mounting surface 605′″.

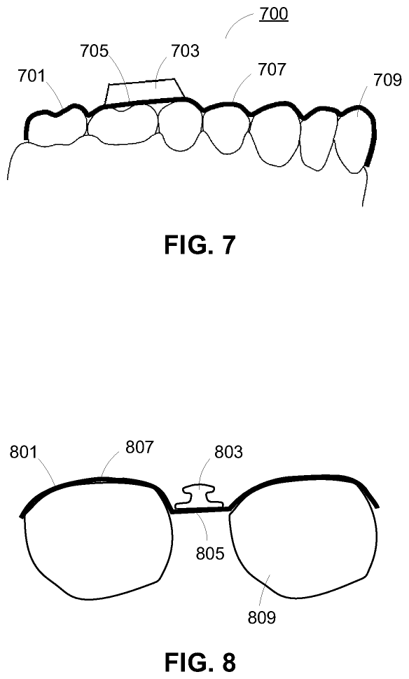

Referring to FIG. 7, it schematically illustrates a shell-shaped dental appliance 700 which includes a shell-shaped body 701 and two occlusal pads 703 mounted thereon. The shell-shaped body 701 forms a cavity 707 for receiving teeth 709, and two accessory mounting surfaces 705 in posterior area on occlusal surface of both sides for mounting the two occlusal pads 703. The accessory mounting surfaces 705 are plane and has a rectangular edge contour, they match the mounting surfaces on the bottoms of the occlusal pads 703. A surface opposite to each accessory mounting surface 705 is in contact with the teeth beneath it on at least two points.

Referring to FIG. 8, it schematically illustrates a cross-section of an accessory mounting surface 805 and a button 803 mounted thereon according to another embodiment.

A shell-shaped body 801 forms a cavity 807 for receiving teeth 809 and the accessory mounting surface 805 having the button 803 mounted thereon. The accessory mounting surface 805 is between a gap between two adjacent teeth, and has artificially designed geometry and edge contour which match that of a mounting surface on the bottom of the button 803.

While various aspects and embodiments have been disclosed herein, other aspects and embodiments will be apparent to those skilled in the art, inspired by the present application. The various aspects and embodiments disclosed herein are for illustration only and are not intended to be limiting, and the scope and spirit of the present application shall be defined by the following claims.

Likewise, the various diagrams may depict exemplary architectures or other configurations of the disclosed methods and systems, which are helpful for understanding the features and functions that can be included in the disclosed methods and systems. The claimed invention is not restricted to the illustrated exemplary architectures or configurations, and desired features can be achieved using a variety of alternative architectures and configurations. Additionally, with regard to flow diagrams, functional descriptions and method claims, the order in which the blocks are presented herein shall not mandate that various embodiments of the functions shall be implemented in the same order unless otherwise the context specifies.

Unless otherwise specifically specified, terms and phrases used herein are generally intended as “open” terms instead of limiting. In some embodiments, use of phrases such as “one or more”, “at least” and “but not limited to” should not be construed to imply that the parts of the present application that do not use similar phrases intend to be limiting.

We claim:

1. A body of a dental appliance, the body being a one-piece shell which forms a cavity for receiving a plurality of teeth and a first mounting surface for mounting a first accessory by bonding the first mounting surface and a second mounting surface of the first accessory, where the first mounting surface has artificially designed geometry and edge contour which substantially match that of the second mounting surface.

2. The body of the dental appliance of claim 1, wherein the first mounting surface is one of a plane and a revolved surface.

3. The body of the dental appliance of claim 1, wherein the whole first mounting surface is raised outwards, and there is space between a surface opposite to the first mounting surface and a tooth/teeth beneath it.

4. The body of the dental appliance of claim 1, wherein the first accessory is one of the following: occlusal pad, button, bracket, bite stop and twin-block.

5. The body of the dental appliance of claim 1, wherein the first mounting surface is for mounting the first accessory by adhesion.

6. The body of the dental appliance of claim 5, wherein the first mounting surface is slightly larger than the second mounting surface.

7. The body of the dental appliance of claim 1, wherein the first mounting surface constitutes a part of the outer surface of the body.

8. The body of the dental appliance of claim 1, wherein the body forms an outward protruding structure on the edge of the first mounting surface, and the first mounting surface is surrounded by the outward protruding structure.

9. The body of the dental appliance of claim 1, wherein a surface opposite to the first mounting surface is in contact with a tooth/teeth beneath it on at least one point.

10. The body of the dental appliance of claim 1, wherein the first mounting surface is part of the outer surface of the body, and the outer surface of the body generally conforms to the teeth the cavity receives except the first mounting surface.

11. A dental appliance, comprising:
a body, which is a one-piece shell and forms a cavity for receiving a plurality of teeth and a first mounting surface; and
a first accessory having a second mounting surface;
wherein the first mounting surface has artificially designed geometry and edge contour which substantially match that of the second mounting surface, and the first accessory is mounted on the body by bonding the first mounting surface and the second mounting surface.

12. The dental appliance of claim 11, wherein the first mounting surface is one of a plane and a revolved surface.

13. The shell-shaped dental appliance of claim 11, wherein the whole first mounting surface is raised outwards, and there is space between a surface opposite to the first mounting surface and a tooth/teeth beneath it.

14. The dental appliance of claim 11, wherein the first accessory is one of the following: occlusal pad, button, bracket, bite stop and twin-block.

15. The dental appliance of claim 11, wherein the first mounting surface constitutes a part of the outer surface of the body.

16. The dental appliance of claim 11, wherein the first accessory is mounted on the first mounting surface by adhesion.

17. The dental appliance of claim 11, wherein the first mounting surface is slightly larger than the second mounting surface.

18. The dental appliance of claim 11, wherein the body forms an outward protruding structure on the edge of the first mounting surface, and the first mounting surface is surrounded by the outward protruding structure.

19. The dental appliance of claim 11, wherein a surface opposite to the first mounting surface is in contact with a tooth/teeth beneath it on at least one point.

20. The dental appliance of claim 11, wherein the first mounting surface is part of the outer surface of the body, and the outer surface of the body generally conforms to the teeth the cavity receives except the first mounting surface.

21. A system for aligning teeth of a patient, wherein it comprises at least two dental appliances for incrementally aligning teeth of a patient from a first tooth arrangement to a second tooth arrangement, each of the at least two dental appliances comprises a body, which is a one-piece shell and forms a cavity for receiving the teeth of the patient and a first mounting surface on a predetermined position for mounting a first accessory by bonding the first mounting surface and a second mounting surface of the first accessory, wherein the first mounting surface has artificially designed geometry and edge contour, wherein the first mounting surfaces of the bodies of the at least two dental appliances are same.

22. The system of claim 21, wherein the first mounting surface's geometry and edge contour substantially match that of the second mounting surface.

23. The system of claim 21, wherein of each of the at least two dental appliances, the first mounting surface is part of the outer surface of the body, and the outer surface of the body generally conforms to a corresponding tooth arrangement except the first mounting surface.
